(19) United States
(12) Patent Application Publication
(10) Pub. No.: US 2009/0307253 A1
(43) Pub. Date: Dec. 10, 2009

(54) COMPUTER SYSTEM FOR GENERATING RANDOM SAMPLE IN RESPONSE TO SEARCH QUERY

(76) Inventors: James Hageman, West Granby, CT (US); Irene Mach, Plantsville, CT (US); J. Scott Dorris, Glastonbury, CT (US); Vani Balakrishnan, Newington, CT (US)

Correspondence Address: BUCKLEY, MASCHOFF & TALWALKAR LLC, 50 LOCUST AVENUE, NEW CANAAN, CT, 06840, US

(21) Appl. No.: 12/132,891

(22) Filed: Jun. 4, 2008

(51) Int. Cl. G06F 17/30

(52) U.S. Cl. 707/102; 707/E17.001

(57) ABSTRACT

A computer system includes a data storage device and a first computer processor in communication with the data storage device. At least one input device and a first program memory are in communication with the first computer processor. The computer system also includes a second computer processor in communication with the first computer processor. At least one other input device, a display device and a second program memory are in communication with the second computer processor. The first computer processor produces a random sampling of files from a set of files that match a set of parameters defined using the input device coupled to the first computer processor. The random sampling of files is displayed on the display device coupled to the second computer processor.

### FIELD

The present invention relates to computer systems and more particularly to computer systems that handle database search queries.

### BACKGROUND

It is well known to generate a search query to obtain selected information of interest from a mass of data, such as a database. Sometimes the amount of information returned in response to a search query is excessive for the user's purposes, or the time required to complete the search is excessive.

U.S. Pat. No. 5,878,426, issued to Plasek et al., describes a process in which an attribute of a database table is sampled, and then a query is applied to the sampled data to arrive at an approximate characterization of the entire contents of the database.

The present inventors have recognized that an alternative manner of combining random sampling with query-based searching may provide utility in other situations.

### SUMMARY

A computer system is disclosed which includes a data storage device and a first computer processor that is in communication with the data storage device. The computer system further includes at least one first input device in communication with the first computer processor. Further included in the computer system is a first program memory, coupled to the first computer processor.

The data storage device stores a database of insurance claim files in electronic form. The at least one first input device inputs signals to define a set of parameters of the insurance claim files. The first program memory stores program instruction steps for execution by the first computer processor.

The first computer processor is operative pursuant to the stored program instruction steps to: (a) receive the signals from the at least one first input device; (b) retrieve from the database a first set of insurance claim files which match the defined set of parameters; and (c) generate a reduced set of insurance claim files, where the reduced set is a random sampling of the first set of insurance claim files.

The computer system also includes a second computer processor in communication with the first computer processor. Also included in the computer system are at least one second input device in communication with the second computer processor, and a display device in communication with the second computer processor. Still further included in the computer system is a second program memory, which is coupled to the second computer processor and which stores program instruction steps for execution by the second computer processor.

The second computer processor is operative pursuant to the program instruction steps stored in the second program memory to: (a) display at least some of the insurance claim files of the reduced set on the display device; and (b) receive, via the at least one second input device, input from a reviewer to perform an internal review with respect to the insurance claim files displayed on the display device.

Such a computer system allows for efficient and statistically valid sampling of insurance claim files for various internal review purposes.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram that illustrates a computer system provided in accordance with aspects of the present invention.

FIG. 2 is a block diagram that illustrates a server computer that is included in the system of FIG. 1.

FIG. 2A is a block diagram that illustrates a typical one of a plurality of user computers included in the system of FIG. 1.

FIG. 3 is a flow chart that illustrates a process that may be performed in the system of FIG. 1 in accordance with aspects of the present invention.

FIG. 4 is a flow chart that illustrates a process that may be performed in the system of FIG. 1 in accordance with aspects of the present invention.

### DETAILED DESCRIPTION

In general, and for the purposes of introducing concepts of embodiments of the present invention, a search query in a computer system is used to define a set of insurance claim files. The set of insurance claim files is retrieved from mass storage and then is randomly sampled, and the sample of files is assigned for purposes of internal review.

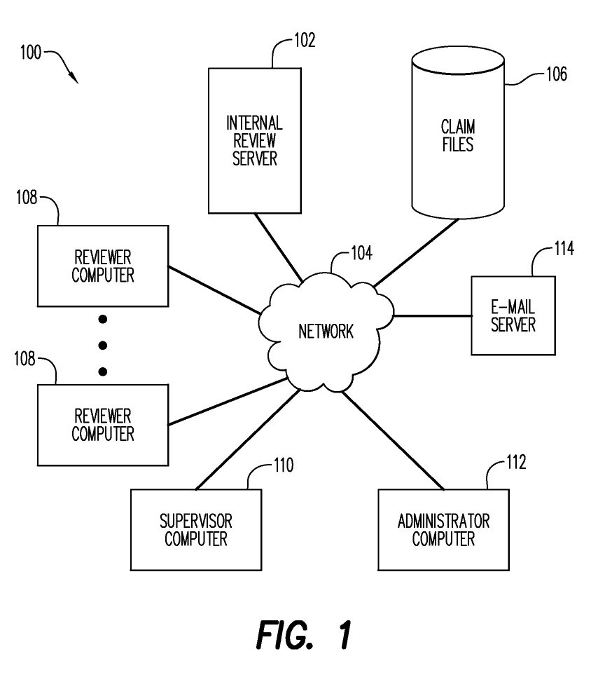

Features of some embodiments of the present invention will now be described by first referring to FIG. 1. FIG. 1 is a block diagram that illustrates a computer system 100 provided in accordance with aspects of the present invention. For present purposes it will be assumed that the computer system 100 is operated by an insurance company (not separately shown). Possibly among other purposes and functions, the computer system may allow for storage and management of electronic files relating to insurance claims made to the insurance company. The claims may be from one or more different lines of insurance, such as worker's compensation, property and casualty, etc.

The computer system 100, as depicted in FIG. 1, includes a server computer 102. Possibly among other functions, the server computer may provide functionality for internal review of the company's operations. Thus the server computer 102 may be referred to as an “internal review server computer”, notwithstanding that it may perform other functions as well.

As seen from FIG. 1, the computer system 100 may further include a conventional data communication network 104 to which the internal review server computer 102 is coupled.

FIG. 1 also shows, as part of computer system 100, a data storage device 106 that is coupled to the data communication network 104. The data storage device 106 may, for example, be constituted by one or more hard disk drives and/or any other known mass data storage device. Although shown as separate from the internal review server computer 102, in practice the data storage device 106 may be integrated with the internal review server computer 102. To make the same point in another way, the computer system utilized by the insurance company as the central repository of electronic claim files may also perform functions for managing and facilitating internal review activities, as described herein.

Still further, FIG. 1 shows, as parts of the computer system 100, personal computers 108 assigned for use by internal reviewers (who are employees of the insurance company) and personal computers 110, 112 assigned for use respectively by a supervisor of the internal reviewers and an administrator of the internal review computer system. The personal computers 108, 110, 112 are coupled to the data communication network 104. Although only one supervisor computer 110 and one administrator computer 112 are shown in the drawing, in practice there may be more than one supervisor of internal reviewers, and more than one system administrator, and each may have his/her own personal computer coupled to the data communication network 104.

Also included in the computer system 100, and coupled to the data communication network 104, is an electronic mail server computer 114. The electronic mail server computer 114 provides a capability for electronic mail messages to be exchanged among the other devices coupled to the data communication network 104.

Thus the electronic mail server computer 114 may be part of an electronic mail system included in the computer system 100.

The computer system 100 may also be considered to include further personal computers (not shown), including, e.g., computers which are assigned to individual claim handlers or other employees of the insurance company.

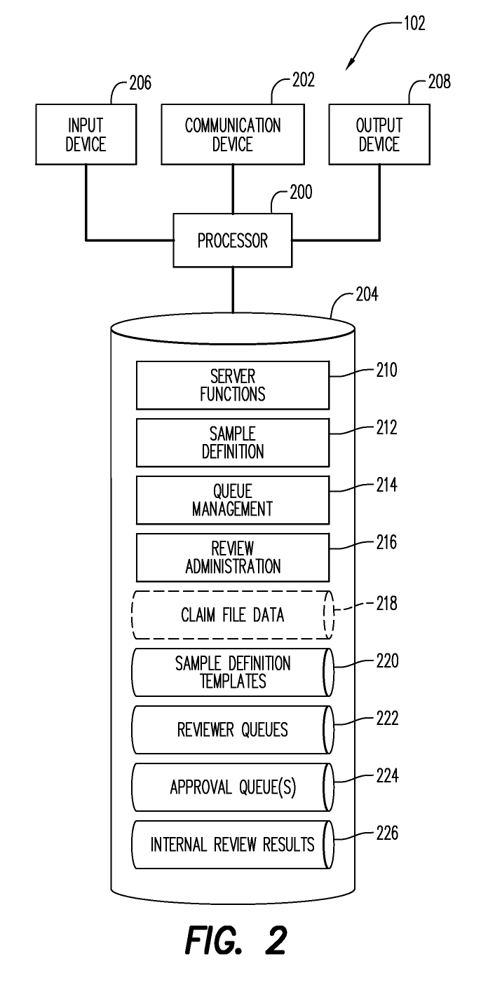

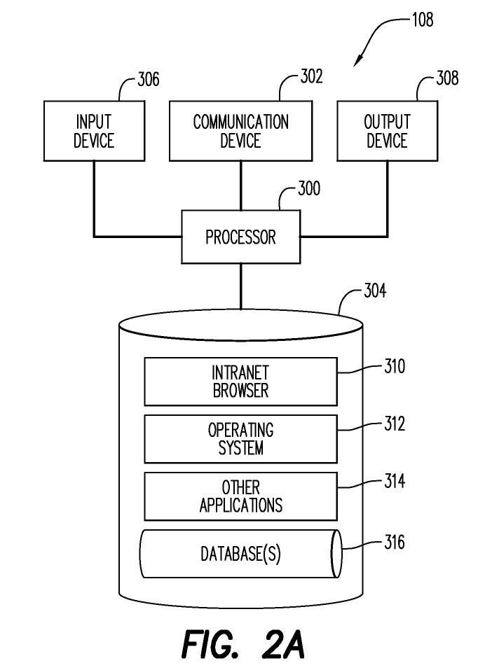

FIG. 2 is a block diagram that illustrates the internal review server computer 102 shown in FIG. 1.

As depicted, the internal review server computer 102 includes a computer processor 200 operatively coupled to a communication device 202, a storage device 204, one or more other input devices 206 and one or more output devices 208. Communication device 202 may be used to facilitate communication with, for example, other devices (such as personal computers assigned to individual employees of the insurance company and shown in FIG. 1). The input device(s) 206 may comprise, for example, a keyboard, a keypad, a mouse or other pointing device, a microphone, knob or a switch, an infra-red (IR) port, a docking station, and/or a touch screen. The input device(s) 206 may be used, for example, to enter information. Output device(s) 208 may comprise, for example, a display (e.g., a display screen), a speaker, and/or a printer.

Storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

In some embodiments, the hardware aspects of the internal review server computer 102 may be entirely conventional.

Storage device 204 stores one or more programs or portions of programs (at least some of which being indicated by blocks 210-216) for controlling processor 200. Processor 200 performs instructions of the programs, and thereby operates in accordance with the present invention. In some embodiments, the programs may include a program or program module 210 that programs the internal review server computer 102 to perform server functions. Program 210 may be provided in accordance with conventional practices.

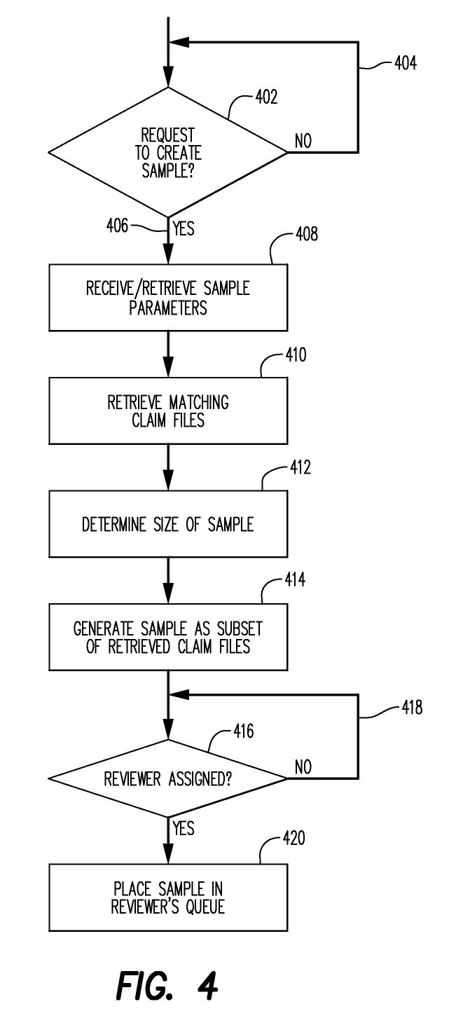

Another program or program module stored on the storage device 204 is indicated at block 212 and is operative to allow the internal review server computer 102 to define samples of electronic claims files that are to be subjected to internal review. The manner in which program 212 operates is described below, in conjunction with FIG. 4, for example. Program 212 is provided in accordance with aspects of the present invention.

Still another program or program module stored on the storage device 204 is indicated at block 214 and manages queues of electronic claim files that have been assigned for review by internal reviewers or by their supervisor(s). Aspects of program 214 are described below, in conjunction with FIG. 4. Program 214 is provided in accordance with aspects of the present invention.

Storage device 204 also stores a program/program module 216, which operates to guide internal reviewers in internal review activities.

There may also be stored in the storage device 204 other software, such as one or more conventional operating systems, device drivers, communications software, etc.

Still further, the storage device 204 may store various databases that are employed in connection with claim file internal review activities. Such databases are illustrated in FIG. 2 as blocks 218-226.

Database 218, shown in phantom, contains electronic claim files available and/or selected for internal review. In some embodiments, such as those in which the internal review server computer 102 and the data storage device 106 shown in FIG. 1 are integrated together, the electronic claim files database 218 may contain a large part, or even all, of the electronic claim files of the insurance company that have not been archived. In still other embodiments, the database 218 may contain electronic claim files selected for internal review and copied from the data storage device 106 to the internal review server computer 102. In still other embodiments, electronic claim files stored in the data storage device 106 may be accessible by hyperlink, and hyperlinks pointing to electronic claim files selected for internal review may be routed to internal reviewers/supervisors in a manner described below.

Block 220 in FIG. 2 represents a database of templates defined by the system administrator or other insurance company employee and used to conveniently define sets of electronic claim files to be sampled for selection for internal review.

Database 222 stored in storage device 204 contains queues of selected claim files that have been assigned for internal review by specific reviewers. Database 224 stored in storage device 204 contains one or more queues of claim files for which the internal reviewers have generated a review that is awaiting approval by the reviewers' supervisor(s).

Block 226 in FIG. 2 represents a database of results of internal review activities.

FIG. 2A is a block diagram that illustrates a typical one (in this example, an internal reviewer's computer 108) of the plurality of user computers included in the system of FIG. 1. (It should be understood that the below description of hardware and software aspects of the example reviewer's computer 108 is also generally applicable to the computers 110 and 112 shown in FIG. 1.)

As depicted, the internal reviewer's computer 108 includes a computer processor 300 operatively coupled to a communication device 302, a storage device 304, one or more other input devices 306 and one or more output devices 308. Communication device 302 may be used to facilitate communication with, for example, other devices (such as the internal review server computer 102 and/or other user computers included in the system of FIG. 1). The input device(s) 306 may comprise, for example, a keyboard, a keypad, a mouse or other pointing device, a microphone, knob or a switch, an infra-red (IR) port, a docking station, and/or a touch screen. The input device(s) 306 may be used, for example, to enter information and user instructions, including accessing electronic claim files and performing internal review activities. Output device(s) 308 may comprise, for example, a display (e.g., a display screen), a speaker, and/or a printer. Among other functions, the input device(s) 306 and the output device(s) 308 may be operated to provide and utilize a graphical user interface (GUI) provided by the internal reviewer's computer 108 in accordance with conventional principles.

Storage device 304 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

In some embodiments, the hardware aspects of the internal reviewer's computer 108 may be entirely conventional.

Storage device 304 stores one or more programs or portions of programs (at least some of which being indicated by blocks 310-314) for controlling processor 300. Processor 300 performs instructions of the programs, and thereby operates in accordance with the present invention. In some embodiments, the programs may include an intranet browser 310, which programs the internal reviewer's computer 108 to act as a client device relative to the internal review server computer 102, and thereby to download information from, and/or to access functionality provided by, the internal review server computer 102. The intranet browser 310 may be, in some embodiments, provided in accordance with conventional practices. The functionality accessible via the internal review server computer 102 may allow the internal reviewer's computer 108 to be operated in connection with internal review activities.

The storage device 204 may further store a conventional operating system program 312 as well as other programs 314, such as conventional office productivity software. Still further, the storage device 204 may store one or more databases 316 that contain data used in operation of the internal reviewer's computer 108.

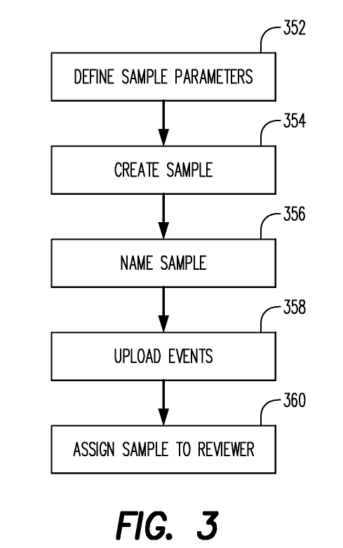

FIG. 3 is a flow chart that illustrates a process that may be performed in the system of FIG. 1 in accordance with aspects of the present invention. In particular, the process of FIG. 3 may, in at least some cases, be performed by using the administrator's computer 112 (FIG. 1) as a client device to access functionality available through the internal review server computer 102. As will be seen, the process of FIG. 3 entails the system administrator or another insurance company employee causing the computer system 100 to generate a sample of electronic insurance claim files that are to be assigned for internal review.

Thus, in some embodiments, at 352 in FIG. 3, the system administrator may interact with a graphical user interface (GUI) to define the parameters for claim files to be sampled for quality assessment review. There are a number of different ways in which the system administrator may do this. Thus, for example, the system administrator may access a screen display by which the system administrator may input signals to define a set of parameters for the claim files to be selected.

For example, one type of parameter that may be defined by the system administrator may be the “line of business” (i.e., the type of insurance such as automobile, general liability, property or workers' compensation). Another type of parameter that may be defined by the system administrator could be the claim handling office or offices from which the claim files are to be selected.

Other input from the system administrator may indicate the type of sampling to be used in generating a random sampling from the claim files that meet the parameters that the system administrator defined. For example, the type of sampling may be indicated by the type of internal review process the system administrator is selecting, be it monthly, quarterly, ongoing, ad hoc, etc. In at least some embodiments, the type of internal review process that the system administrator selects may automatically indicate (by previously stored definition) to the internal review server computer 102 how many claim files are to be included in the sample that the internal review server computer 102 is to generate.

Alternatively, the system administrator may enter a specific number of claim files to be included in the sample to be returned by the computer system 100. In addition or alternatively, the system administrator may define a time period (e.g., by date of claim, or date of resolution of the claim) from which the sample of claim files is to be drawn. In another embodiment, the system administrator may specify a dollar limit or limits (e.g., by amount paid to resolve the claim) to at least partially define the set of claim files from which the sample is to be drawn.

Still further, the system administrator may be permitted to specify the amount of time the claim was pending (i.e., elapsed time from receipt of the claim to resolution) as a parameter for defining the set of claim files to be sampled by the computer system 100. (In this case, the computer system 100 may be required to calculate the amount of the time each file was pending as it screens the claim files to determine which satisfy this parameter.)

Other parameters that may be used to define the set of claim files to be sampled may include attributes of the claimant, such as age, gender, marital status, employment status, etc.

According to other aspects of the invention, the computer system 100 may allow the system administrator to define and store templates for future claim file search queries. With use of such templates, the system administrator may pre-define at least some parameters for a claim file search query.

At 354 in the flow chart of FIG. 3 a sample is created by launching a search of the claim file data based on a search query. In effect, after the user launches the search, the computer system 100 takes over and returns a random sample of claim files that match the search query. Details of the actions taken by the computer system 100 (and particularly by the internal review server computer 102) will be discussed below in conjunction with FIG. 4.

Logically but not necessarily temporally subsequent to step 354, is step 356 in FIG. 3, at which a name is applied to the sample of matching claim files returned by the computer system 100. In some embodiments, the user may simply enter the sample name by interacting with a screen display which is not shown. In other embodiments, the template and/or the search query generator automatically generates a suitable name for the sample, possibly subject to modification by the user.

The sample returned by the computer system 100 typically consists of a number of claim files, each associated with a respective event that caused the claimed loss. In practice, then, a claim file may be considered to include the “event file” for the corresponding event. The user may, for example, export the sample of claim files to a spreadsheet program (not shown). Then, from the spreadsheet program, the sample of claim files may be uploaded to an internal review queue management application (214 in FIG. 2). Alternatively, the sample of claim files may be uploaded directly and automatically to the internal review queue management application. (In either case, i.e., whether the uploading of the sample of claim files is automatic or indirect, this process step is indicated at 358 in FIG. 3).

Next, at 360 in FIG. 3, the uploaded sample of claim files is assigned to a particular internal reviewer.

FIG. 4 is a flow chart that illustrates a process that may be performed in the computer system 100 in accordance with aspects of the present invention. In particular, the process of FIG. 4 may be performed by the internal review server computer 102.

The process of FIG. 4 begins at decision block 402. At decision block 402, the internal review server computer 102 determines whether it has received from a user (e.g., via the administrator computer 112) a request to create a sample of claim files for internal review. Until such an event occurs, the process of FIG. 4 idles, as indicated by branch 404. However, if such an event has occurred (e.g., by the user initiating step 354 in FIG. 3), then the internal review server computer 102 makes a positive determination at decision block 402 and the process advances via branch 406 to block 408.

At block 408, the internal review server computer 102 receives the search query parameters which define from what set of claim files the sample is to be drawn. That is, the search query parameters may be received by the internal review server computer 102 in the search query initiated by the user. Alternatively, the internal review server computer 102 may look up and retrieve the claim file parameters to be matched if the search query refers to a previously defined search query generator or template without specifying the search query parameters in the query itself. In any case, and as indicated at 410 in FIG. 4, the internal review server computer 102 uses the parameters to search the claim file database (106 in FIG. 1 and/or 218 in FIG. 2) in order to retrieve all available claim files that match the search query parameters.

At 412 in FIG. 4, the internal review server computer 102 determines what is to be the size (i.e., number of files) of the sample to be drawn from the set of query-matching claim files retrieved at 410. This may be done simply by reading a sample size specified in the search query generated by the user. Alternatively, however, and in cases in which the sample size is not specified by the user, the internal review server computer 102 may automatically determine a suitable size for the sample. For example, the internal review server computer 102 may calculate what size of sample is needed to provide a statistically valid sampling of the set of retrieved claim files, given the number of files in the set of retrieved claim files.

As still another alternative, the internal review server computer may set the sample size as specified by prior definition for the type of review indicated in the search query.

At 414, the internal review server computer 102 randomly samples the set of matching claim files generated at 410 to produce a reduced set of matching files that is equal in size to the number of files determined at 412. The internal review server computer 102 may return this reduced set of files (or file identifiers that identify the files in the reduced set of files) to the user as the response to the user's search query.

Decision block 416 follows block 414. At decision block 416, the internal review server computer 102 determines whether the user (or a different user) has provided input to assign the reduced set of files generated at 418 to a reviewer. If not, the process idles, as indicated at branch 418. However, if a user has provided such input, then the process advances from decision block 416 to block 420. At 420, the internal review server computer 102 places the reduced sample in a queue of files to be reviewed by the assigned reviewer.

In some embodiments, the internal review activities undertaken by the assigned reviewer may provide useful feedback concerning the manner in which the insurance company handles claims.

In some embodiments, some or all of the communications among insurance company employees may be via the electronic mail system referred to above in conjunction with FIG. 1.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system comprising:
a data storage device which stores a database of insurance claim files in electronic form;
a first computer processor in communication with the data storage device;
at least one first input device in communication with the first computer processor for inputting signals to define a set of parameters of the insurance claim files;
a first program memory, coupled to the first computer processor, for storing program instruction steps for execution by the first computer processor, the first computer processor operative pursuant to the stored program instruction steps to:
receive the signals input from the at least one first input device;
retrieve from the database a first set of insurance claim files which match the defined set of parameters; and
generate a reduced set of insurance claim files, said reduced set being a random sampling of the first set of insurance claim files;
a second computer processor in communication with the first computer processor;
at least one second input device in communication with the second computer processor;
a display device in communication with the second computer processor; and
a second program memory, coupled to the second computer processor, for storing program instruction steps for execution by the second computer processor, the second computer processor operative pursuant to the program instruction steps stored in the second program memory to:
display at least some of the insurance claim files of the reduced set on the display device; and
receive, via the at least one second input device, input from a reviewer to perform an internal review with respect to the insurance claim files displayed on the display device.

2. The computer system of claim 1, wherein the first computer processor is operative pursuant to the program instruction steps stored in the first program memory to automatically determine a number of the insurance claim files to be included in the reduced set.

3. The computer system of claim 1, wherein the first computer processor is operative pursuant to the program instruction steps stored in the first program memory to receive input from the at least one first input device to indicate a number of the insurance claim files to be included in the reduced set.

4. The computer system of claim 1, wherein the parameters include a claims handling office.

5. The computer system of claim 1, wherein the parameters include a range of dates.

6. The computer system of claim 1, wherein the parameters include a type of insurance policy.

7. The computer system of claim 1, wherein the parameters include a type of internal review process.

8. The computer system of claim 7, wherein the first computer processor is operative pursuant to the program steps stored in the first program memory to automatically determine a number of insurance claim files to be included in the reduced set based at least in part on the type of internal review process indicated by the defined set of parameters.

9. The computer system of claim 1, wherein the parameters include an amount paid to resolve a claim.

10. The computer system of claim 1, wherein the parameters include an amount of time a claim was pending.

11. The computer system of claim 1, wherein the first computer processor is operative pursuant to the program instruction steps stored in the first program memory to receive at least one signal from the at least one first input device for assigning the reduced set of insurance claim files for review by the reviewer.

12. The computer system of claim 1, wherein the first computer processor is operative pursuant to the program instruction steps stored in the first program memory to automatically load the reduced set of insurance claim files into an internal review software tool.

13. The computer system of claim 1, wherein the first computer processor is operative pursuant to the program instruction steps stored in the first program memory to allow a user to input signals to load the reduced set of insurance claim files into an internal review software tool.

14. A method comprising:
storing a database of insurance claim files;
receiving signals for defining a set of parameters of the insurance claim files;
retrieving from the database a first set of insurance claim files which match the defined set of parameters;
generating a reduced set of insurance claim files, said reduced set being a random sampling of the first set of insurance claim files;
displaying at least some of the insurance claim files on a display device; and
receiving input from a reviewer to perform an internal review with respect to the insurance claim files displayed on the display device.

15. The method of claim 14, further comprising:
automatically loading the reduced set of insurance claim files into an internal review software tool.

16. The method of claim 14, further comprising:
allowing a user to input signals to load the reduced set of insurance claim files into an internal review software tool.

17. The method of claim 14, further comprising:
automatically determining a number of the insurance claim files to be included in the reduced set.

18. The method of claim 14, further comprising:
receiving input that indicates a number of the insurance claim files to be included in the reduced set.

19. The method of claim 14, wherein the parameters include a claims handling office.

20. The method of claim 14, wherein the parameters include a range of dates.
